(19) United States
(12) Patent Application Publication
(10) Pub. No.: US 2015/0052457 A1
(43) Pub. Date: Feb. 19, 2015

(54) METHOD AND SYSTEM FOR PROVIDING LIKE OR DISLIKE INFORMATION BY USING ADDRESS BOOK

(71) Applicant: Su Gene Kim, Seoul (KR)

(72) Inventor: Su Gene Kim, Seoul (KR)

(21) Appl. No.: 14/461,340

(22) Filed: Aug. 15, 2014

(30) Foreign Application Priority Data
Aug. 16, 2013 (KR) 10-2013-0097406

(51) Int. Cl. G06F 17/30; G06F 3/0484; H04L 29/08; G06F 3/0481

(52) U.S. Cl. CPC G06F 17/30595; G06F 3/0481; G06F 3/04842; H04L 67/10
USPC 715/753

(57) ABSTRACT

Provided are a method and system for providing like or dislike information by using an address book. The like or dislike information providing system using an address book includes: a classification information receiving unit for receiving classification information, which is obtained when a first user selects a second user who is registered in an address book of a terminal of the first user into one of predetermined categories, from the terminal of the first user; a like or dislike information generating unit for generating like or dislike information that shows a like or a dislike which a third user, who registered the second user in an address book, has about the second user by using the classification information; and a like or dislike information providing unit for providing the generated like or dislike information to the terminal of the second user, and the like or dislike information providing method using the same.

### RELATED APPLICATION

This application claims the benefit of Korean Patent Application No. 10-2013-0097406, filed on Aug. 16, 2013, in the Korean Intellectual Property Office, the disclosure of which is incorporated herein in its entirety by reference.

### BACKGROUND

1. Field

One or more embodiments of the present invention relate to a method and system for providing like or dislike information by using an address book, and more particularly, to a method and system for generating like or dislike information that shows how each user feels about other people and providing the like or dislike information to each user, by using information obtained when each user classifies other people, who are registered in an address book of a user's terminal, according to a like or dislike about the other people.

2. Description of the Related Art

Some wired phones or computers, as well as mobile terminals such as a feature phone or a smartphone, have functions in which a user may store phone numbers, e-mail addresses, or addresses of acquaintances in an address book.

According to conventional research regarding an address book, a method of synchronizing an address book registered in a mobile terminal of a user with a server (Korea Patent Publication No. 2005-77438), a method of calling and using an address book registered in a mobile terminal of a user (Korea Patent Publication No. 2009-1329), or so on have been employed.

Information in an address book may be stored into one category without any classification. However, a user may determine a category and classify contact information registered in an address book. If how a user classifies acquaintances registered in an address book is understood, a relationship between the registered acquaintances and a user or how the user feels about the acquaintances may be inferred.

By integrating such information of classification, how a user feels about another person or how another person feels about the user may be understood. However, research into a service of providing such information has not been conducted.

### SUMMARY

One or more embodiments of the present invention include a method and system for providing like or dislike information by using an address book so as to solve a problem described above.

One or more embodiments of the present invention include non-transitory computer-readable recording storage medium having stored thereon a computer program, which when executed by a computer, for performing the method, so as to solve such a problem.

Additional aspects will be set forth in part in the description which follows and, in part, will be apparent from the description, or may be learned by practice of the presented embodiments.

According to one or more embodiments of the present invention, a like or dislike information providing system using an address book includes: a classification information receiving unit for receiving classification information, which is obtained when a first user selects second users who are registered in an address book of a terminal of the first user into one of predetermined categories, from the terminal of the first user; a like or dislike information generating unit for generating like or dislike information that shows a like or a dislike which a third user, who registered the first user in an address book, has about the first user by using the classification information; and a like or dislike information providing unit for providing the generated like or dislike information to the terminal of the first user.

According to one or more embodiments of the present invention, a like or dislike information providing method using an address book includes: receiving classification information, which is obtained when a first user selects second users who are registered in an address book of a terminal of the first user into one of predetermined categories, from the terminal of the first user; generating like or dislike information that shows a like or a dislike which a third user, who registered the first user in an address book, has about the first user by using the classification information; and providing the generated like or dislike information to the terminal of the first user.

The classification information may include momentary classification information that shows how the first user felt about the second user for a certain time period, and the like or dislike information may include information that is obtained by integrating the momentary classification information regarding the first user for the certain time period.

The like or dislike information may include information that shows, if the first user has classified the second users into a certain first category, whether a case when a person from among the second users who are classified into the first category classifies the first user into the first category is present.

With respect to a user who is classified into a certain second category from among the categories by other persons at a certain or higher rate, the like or dislike information providing unit may generate information for outputting information, which shows the user is classified into the second category at the certain or higher rate, to an item that represents the user in the address book in which the user is registered.

A non-transitory computer-readable recording storage medium having stored thereon a computer program, which when executed by a computer, for performing a like or dislike information providing method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic diagram for explaining a concept according to the present invention;

FIG. 2 is a block diagram of a configuration of a system according to the present invention;

FIGS. 3 and 4 are diagrams illustrating examples of categories for classification according to the present invention;

FIG. 5 is a diagram of a screen of an address book, which is displayed when one of the categories shown in FIG. 3 or 4 is selected;

FIG. 6 is a diagram illustrating an example of a screen that shows a category into which another person classifies a user;

FIG. 7 is a diagram illustrating an example of a screen that shows a result of classification which is performed by a first user;

FIG. 8 is a diagram illustrating an example of a screen that shows an analysis result with respect to momentary classification information according to the present invention;

FIG. 9 is a flowchart of a method according to the present invention; and

FIG. 10 is a flowchart for showing an example of outputting like or dislike information of a person, when the person is selected from among persons provided in an address book, according to the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

In the present invention, if a user of a terminal classifies acquaintances who are registered in an address book of the user into one of preset categories, information regarding how the user feels about the acquaintances and information about how the acquaintances feel about the user may be provided by using information that is obtained when the user classifies the acquaintances.

In the present invention, a terminal includes all types of terminals which have a communication function and an address book function, such as a wired phone, a desktop computer, a notebook computer, and so on, as well as a mobile terminal such as a feature phone or a smartphone.

For convenience of description of the present invention, a user is defined in advance as follows:

A user refers to one or all users selected from the group consisting of a first user, a second user, and a third user. A first user means a user who owns a terminal and performs classification with regard to an address book of the terminal.

Additionally, a second user means a user who is registered in an address book of the first user. A third user means a user who has registered the first user for an address book of the third user. The second user may or may not match the third user.

Hereinafter, the present invention will be described more fully with reference to the accompanying drawings, in which exemplary embodiments of the invention are shown.

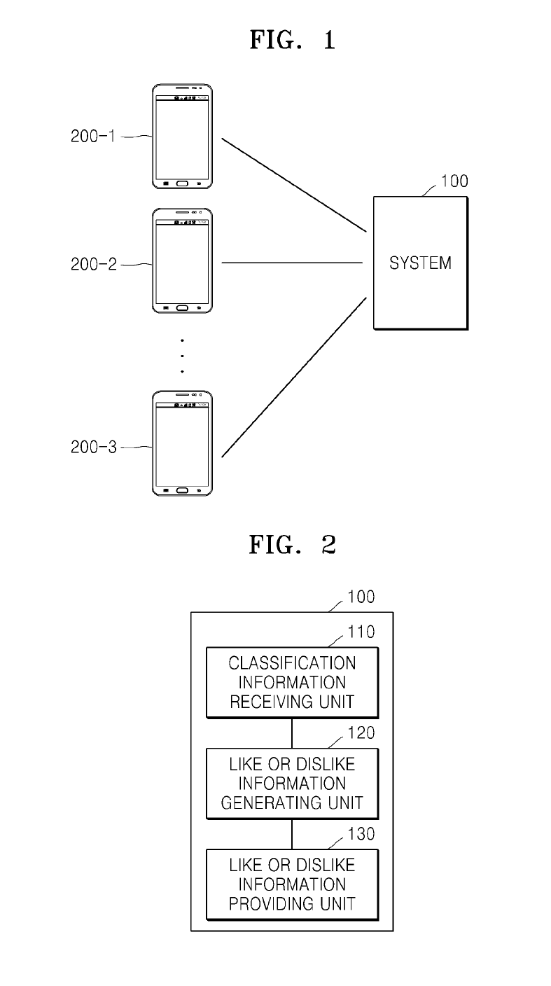

FIG. 1 is a schematic diagram for explaining a concept according to the present invention.

In the present invention, a system 100 is implemented in the form of a server which performs wired and wireless communication with an application program installed in user terminals 200-1, 200-2, and 200-n. In the present invention, the system 100 provides like or dislike information regarding how each user feels about another user, by using an address book installed in each user's terminal and information obtained when a user (a first user) classifies respective persons (second users) who are registered in the address book.

FIG. 1 only shows a mobile terminal as a terminal. However, in the present invention, a terminal may include all types of terminals that have a communication function and an address book function, such as a wired phone, a desktop computer, a notebook computer, and so on, as well as a mobile terminal such as a feature phone or a smartphone.

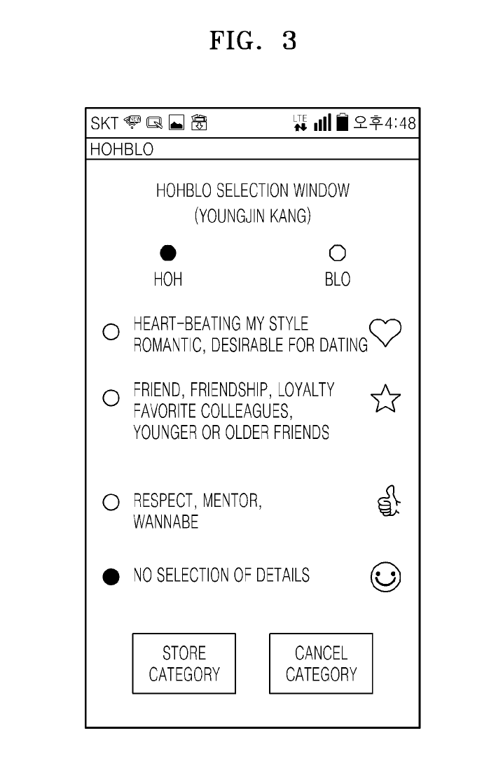

FIG. 2 is a block diagram of a configuration of a like or dislike information providing system 100 according to the present invention.

In the present invention, the like or dislike information providing system 100 includes a classification information receiving unit 110, a like or dislike information generation unit 120, and a like or dislike information providing unit 130.

If a first user performs a classification operation by selecting one of preset categories with respect to second users registered in an address book of the first user's terminal, the classification information receiving unit 110 receives classification information, obtained by performing the classification operation, from the first user's terminal.

In the present invention, an address book may be an address book that is used in an application program to which the present invention is applied.

A user may register contact information of acquaintances (second users) directly in the address book. Alternately, a user may obtain information by acquiring address book information from an address book such as an address book basically provided in a mobile terminal, other than an address book of the application program to which the present invention is applied, and synchronizing the address book information with the address book of the application program to which the present invention is applied.

The application program to which the present invention is applied may be a program that is employed only for a purpose of the present invention, which will be described later, or may be a program that includes another function in addition to a function provided by the present invention, such as a messenger or a game.

Classification information is obtained when a first user performs classification by selecting one of preset categories with respect to acquaintances (second users) who are registered in an address book stored in the first user's terminal.

Classification information may be largely classified into two types: one is general classification information, in which a classification result is maintained regardless of a time period after classification is performed once, and the other is momentary classification information for showing a feeling of a first user about a second user for a determined time period such as a day.

General classification information is described as follows:

A category, selected for classification by a first user, is preset by a system designer, and all users may select a category from among same categories.

Such a category may be basically determined according to a criterion for how a first user feels about a second user.

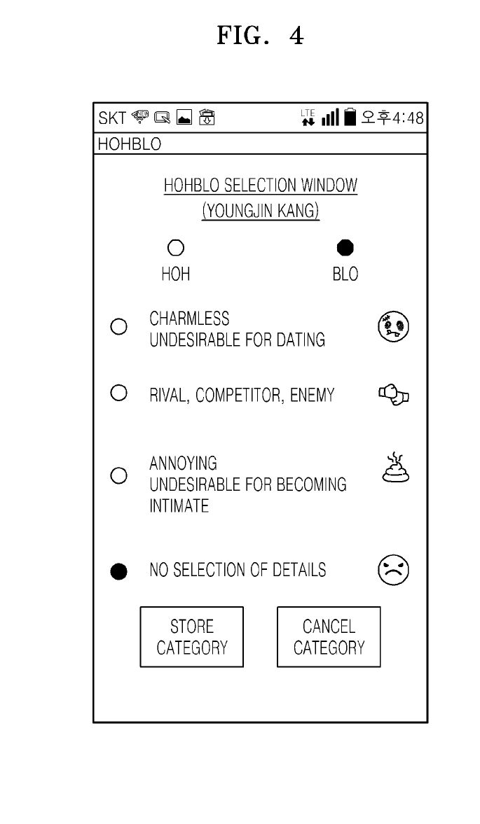

FIGS. 3 and 4 are diagrams illustrating examples of categories for classification according to the present invention. FIG. 3 shows an example in which a first user has a positive feeling (HOH) about a second user. FIG. 4 shows an example in which a first user has a negative feeling (BLO) about a second user.

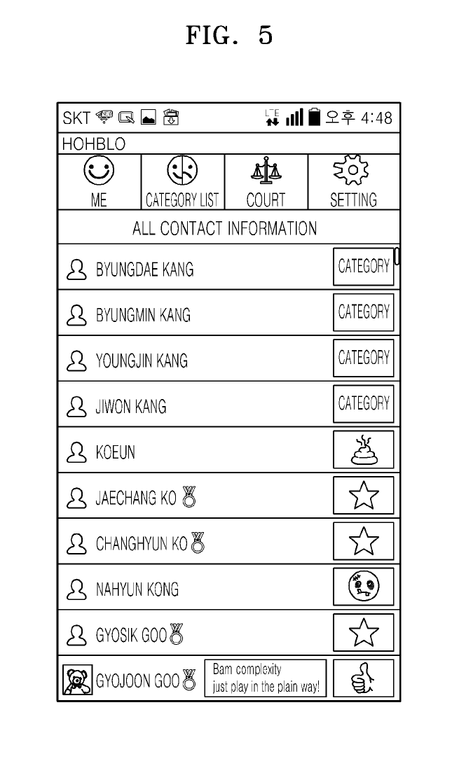

FIG. 5 is a diagram of a screen of an address book, which is displayed when one of the categories shown in FIG. 3 or 4 is selected.

As shown in FIG. 5, if a second user is classified by selecting a category, information that shows the category is output next to the second user.

Referring to the address book of the first user, shown in FIG. 5, how the first user feels about another person may be identified.

Information shown in FIG. 5 shows a result obtained when the first user classifies a second user, registered in the address book, according to an impression that the first user usually has about the second user.

An icon placed next to a name of a person in the address book, shown in FIG. 3 or 4, means that classification of the person into a category of the icon is already complete. ‘Category’ placed next to a name of a person in the address book, shown in FIG. 3 or 4, means that the classification operation is not complete yet.

Classification information, described with reference to FIGS. 3 through 5, is general classification information, wherein the general classification information may be modified by a first user but does not need additional classification after classification is performed once, and a result of the classification is continuously applied and displayed.

Additionally, the first user may set momentary classification information for showing a momentary feeling about one or more second users registered in the address book.

The setting of momentary classification information is not to show how the first user usually feels about the second user but show how the first user feels about the second user for a determined time period such as an hour or a day.

For example, if the second user is the first user's friend and the first user is disappointed with the second user because the second user does not keep a promise one day, a feeling that the first user usually has about the friend may be different from a feeling that the first user has about the second user on the day when the second user does not keep a promise.

In this case, the feeling that the first user usually has about the friend may be classified and displayed by using a method that is described with reference to FIGS. 2 through 4. However, the feeling that the first user has about the second user on the day may be shown by using a method of additionally providing momentary classification information.

A method of setting momentary classification information may vary with cases.

For example, if a first user feels good about a particular person, the first user may select a candy-shaped icon with respect to the person. If a first user feels bad about the person, the first user may select a stone-shaped icon with respect to the person. Then, a result of the selecting may be transmitted to the classification information receiving unit 110.

Additionally, a scoring concept may be applied so that if the first user feels good about a particular person, a value may be added to a score for the person, and if the first user feels bad about the person, a value may be subtracted from a score for the person.

Unlike general classification information, since a user may set momentary classification information to be provided with respect to one person several times, the number of times for providing momentary classification information may be limited so as to prevent overuse of the momentary classification information.

For example, a user may set to provide momentary classification information with respect to only a total of 5 persons a day, and may set to provide momentary classification information with respect to a same person only once a day.

By using momentary classification information, a user may become aware of how other persons feel about the user every day.

Information obtained when a user classifies a second user, registered in an address book of the user's terminal, is transmitted to the classification information receiving unit 110.

Information received by the classification information receiving unit 110 is provided to the like or dislike information generation unit 120. The like or dislike information generation unit 120 generates like or dislike information based on the received information.

Like or dislike information is information generated by using information obtained when each first user, who subscribed for membership of the system in the present invention, classifies second users who are registered in an address book of each first user. Like or dislike information refers to information about how each user feels about other persons or information about how other persons feel about the user.

Representatively, information may include information that shows how each first user is evaluated by other persons.

In detail, even though a first user classifies second users into determined categories according to a feeling of the first user, since the first user may also be registered in an address book of third users, the first user may become aware of how the first user's acquaintance evaluates the first user, by integrating how the third users classify the first user.

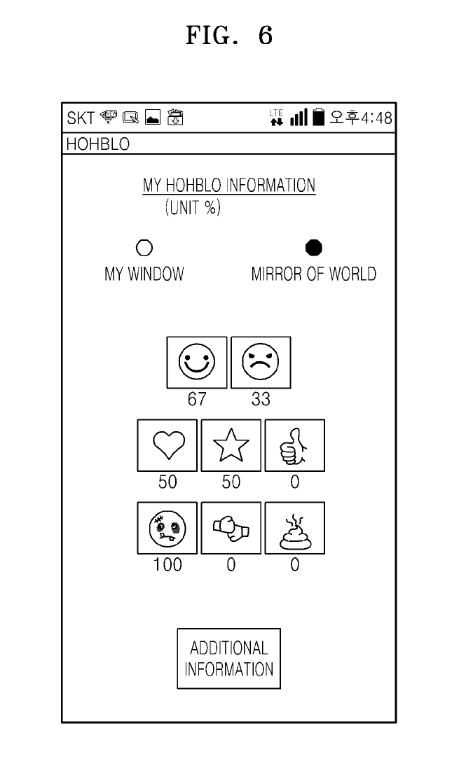

FIG. 6 is a diagram illustrating an example of a screen that shows a category into which another person classifies a first user.

A third user who registered the first user for the third user's address book also selects a category from among the categories shown in FIGS. 3 and 4, The like or dislike information generation unit 120 generates statistics information that shows the number of classification times or a rate of classification for each category, by integrating information included in the address book in which the first user is registered.

In FIG. 6, ‘a mirror of a world’ shows a result of how other people feel about a user.

Referring to FIG. 6, the first user who is a subject of classification may become aware that 67% of persons who registered and classified the first user in their address book feel positive about the first user and 33% of the persons who registered and classified the first user in their address book feel negative about the first user.

Additionally, 50% of persons who feel positive about the first user classify the first user into a category of persons who are ‘romantic and desirable for dating’, and the remaining 50% of the persons who feel positive about the first user classify the first user into a category of ‘favorite colleagues, and younger or older friends’.

Additionally, the persons who feel negative about the first user classify the first user into a category of persons who are ‘annoying and undesirable for dating’.

When generating information shown in FIG. 6, information regarding who classified the first user may not be included.

If such information is provided, since each user may not comfortably classify persons registered in an address book, a purpose of the present invention for providing accurate information regarding how other persons feel about a user may not be achieved.

The like or dislike information generating unit 120 may also generate statistics information regarding how the first user classified the second users, registered in the first user's address book, by using only information of classification performed by the first user.

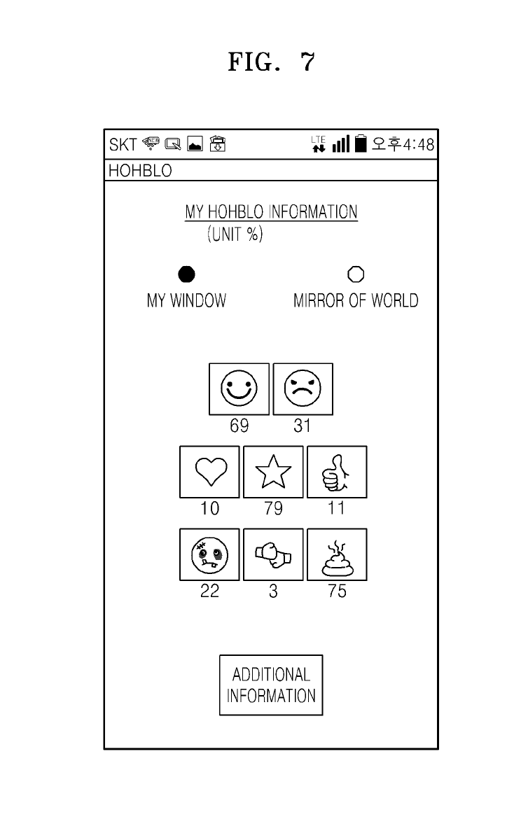

FIG. 7 is a diagram illustrating an example of a screen that shows a result of classification that is performed by a first user. “My window”, shown in FIG. 7, refers to an output of a result of how the first user classifies second users who are registered in the first user's address book.

The result, shown in FIG. 7, may be obtained just by using classification information of one user who uses the address book, without having to use classification information of other users. Thus, the result may be generated by employing an application program included in the user's terminal, instead of employing the system in the present invention, which is implemented in the form of a server provided separately from the user's terminal.

The like or dislike information generating unit 120 generates not only an analysis result of general classification information, but also an analysis result of momentary classification information.

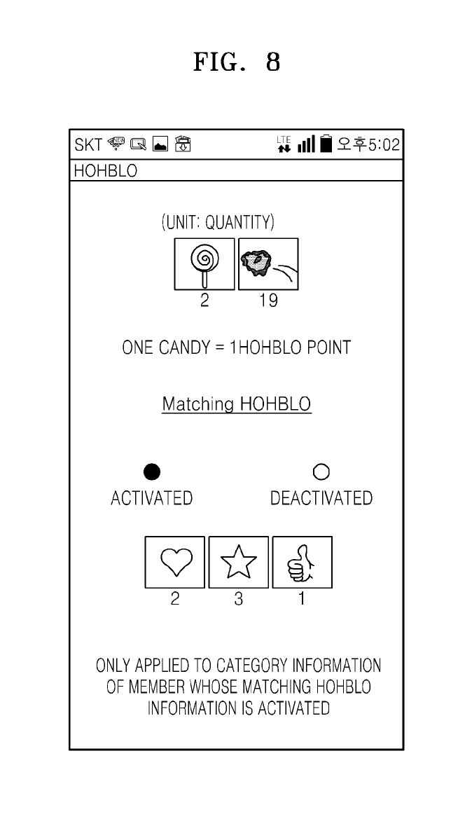

FIG. 8 shows an example of a screen that shows an analysis result with respect to momentary classification information.

Referring to FIG. 8, a user received 2 candies and 19 stones from other persons. According to a result, it may be supposed that the user may have done something that offended other persons.

Momentary classification information is basically generated as information that is accumulated for a determined short time period such as a day. However, information that is accumulated for a long time period, such as a month or a period from a subscription point of time to present, may also be generated.

If a category into which a user classifies a certain person matches a category into which the certain person classifies the user, like or dislike information that is generated from the like or dislike information generation unit 120 may include matching information which informs whether the category into which the user classifies other persons matches the category into which the other persons classify the user, or informs the number of times matching.

In detail, if a person A classifies a person B into the category of persons who are ‘romantic and desirable for dating’, shown in FIG. 2, and the person B also classifies the person B into the same category, information showing that matching information is present in the category or information showing that one piece of matching information is present in the category may be output.

By using such information, if a user is interested in another person, the user may figure out whether the other person is interested in the user.

In other words, if a user classifies only a person A into a category of persons who are ‘desirable for dating’ and if it is identified that matching information is present in the category, the user may become aware that the person A also classified the user into the category of persons who are ‘desirable for dating’.

It may not be identified whether the person A only included the user in the category of persons who are ‘desirable for dating’ or the person A also included other persons in the same category. However, it may be identified that the person A at least has a positive feeling about the user.

By using matching information, a user may infer how another person feels about the user. Thus, matching information may be provided only for a category of a positive feeling, so that users may not have hostile feelings with each other when using the present invention.

Additionally, if a user classifies only one person in a particular category and uses matching information in the category, the user may directly infer how the person classified into the category feels about the user. Accordingly, in order to prevent such direct inferring, matching information may be provided only when a plurality of persons are classified into a category in which matching information is employed.

Additionally, since some people may not want to show their feelings, people who set not to show their feelings may not be taken into account when matching information is generated.

In other words, even when the person A and the person B classify each other into the category of persons ‘who are desirable for dating’, if the person B sets a result of classification, performed by the person B, not to be reflected in matching information, the matching information may not be present when the person A searches for the matching information with respect to the category of ‘persons who are desirable for dating’.

In this case, if a user sets information of classification performed by the user not to be reflected in matching information, the user may be set not to search for matching information.

Based on generated like or dislike information, the like or dislike information generating unit 120 may generate information for outputting to an address book an indication of information regarding users, who are classified into a certain category for a certain or higher rate with respect to general classification information or momentary classification information.

The generated information is transmitted to the user's terminal, and an application program that employs the address book outputs a predetermined icon next to a name in a list in the address book—for example, a medal is displayed next to a person in a list in the address book, as shown in FIG. 5.

If a medal is output because a user is classified into a positive category at a high rate, it may be understood that a user with a medal in an address book is a user who other people have a positive feeling.

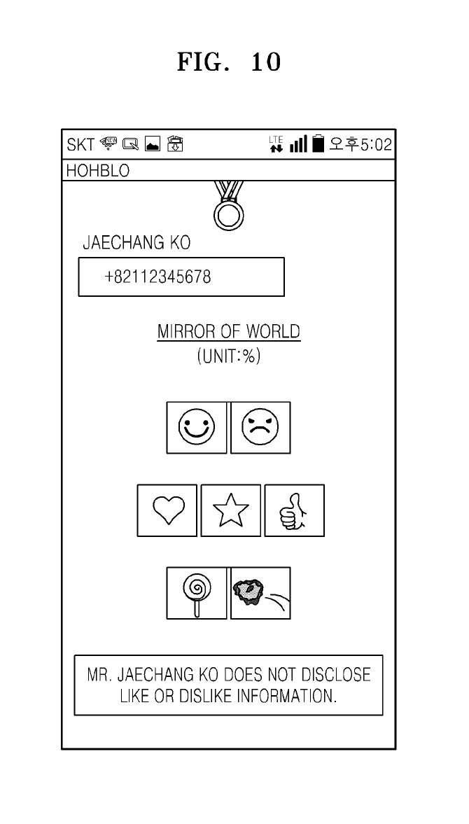

Through the screen shown in FIG. 6, the first user may always be aware of a like or a dislike of the first user by another person, but may not be aware of how other people are evaluated. Information regarding how a certain person is evaluated by other people may be disclosed only when the certain person allows the information to be disclosed. In case a person allows to disclose like or dislike information, if another person that includes the person in an address book selects the person in the address book, like or dislike information of the person is output. Otherwise, if the person sets to prohibit disclosure of like or dislike information, like or dislike information of the person may not be disclosed to the other person, as shown in FIG. 10.

However, exceptionally, in the case of a person who received the medal shown in FIG. 5, since a medal icon is output by all address books of people who registered the person in an address book, the people who registered the person in an address book may also infer how the person who received the medal is evaluated by other people.

Since a medal shows that a person who received the medal has a good reputation (if a medal is set to be provided when a rate at which a person is classified into a positive category is high), people may generally want to receive the medal, and resultantly, may pay attention to personal relationships with others.

The like or dislike information providing unit 130 transmits like or dislike information, generated by the like or dislike information generating unit 120, to a user's terminal so that the like or dislike information is output by the user's terminal.

When the like or dislike information providing unit 130 provides like or dislike information, the like or dislike information may be provided only to users who performed a classification operation on the users' address book at a predetermined or higher rate or for a predetermined number of times or greater.

With regard to general classification information, since like or dislike information is information that shows how another person (a third user) feels about a first user, the first user may use the like or dislike information without having to perform any operations.

However, if like or dislike information is used without restrictions, since the number of people who are to use like or dislike information without performing a classification operation on their address book may increase, it may be difficult to generate accurate like or dislike information. In order to prevent this, it may be desirable to provide like or dislike information only to users who have performed a classification operation on an address book at a predetermined or higher rate or for a predetermined number of times or greater.

Additionally, it may also be desirable not to provide like or dislike information to a user who set not to provide the user's classification information or reflect the user's classification information in matching information.

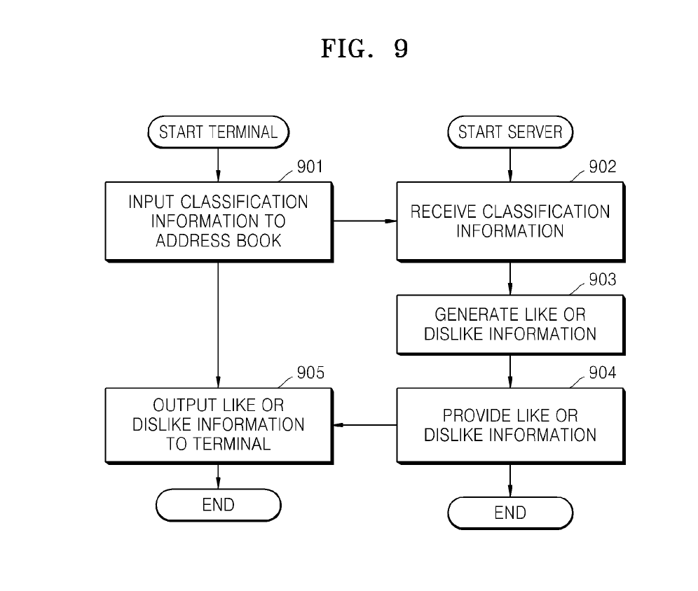

FIG. 9 is a flowchart of a method according to the present invention.

In order to implement the present invention, in operation 901, a first user may perform classification operation on second users, who are registered in an address book stored in a first user's terminal, by using the first user's terminal.

A classification operation is an operation for selecting one of the categories that are preset by a system designer with respect to each second user who is registered in the address book. A screen for performing classification operation and a screen of an address book on which classification operation is performed are shown in FIGS. 3 through 5.

As described above, a user may register contact information of acquaintances (second users) directly in the address book. Alternately, a user may obtain information by acquiring address book information from an address book such as an address book basically provided in a mobile terminal, other than an address book of the application program to which the present invention is applied, and synchronizing the address book information with the address book of the application program to which the present invention is applied.

As also described above, the application program to which the present invention is applied may be a program that is employed only for a purpose of the present invention, or may be a program that includes another function in addition to a function provided in the present invention, such as a messenger or a game.

In operation 902, the classification information receiving unit 110 obtains classification information from the user's terminal.

A method of synchronizing data between a terminal and a server is performed by using well-known technology. Thus, a detail description thereof is not provided here.

As described above, classification information may be largely classified into two types: one is general classification information in which classification result is maintained regardless of a time period after classification is performed once, as shown in FIGS. 3 through 5, and the other is momentary classification information for showing a feeling of a first user about a second user for a determined time period such as a day, as described with reference to candies or stones shown in FIG. 8.

Unlike general classification information, since a user may set momentary classification information to be provided with respect to one person several times, the number of times for providing momentary classification information may be limited so as to prevent overuse of the momentary classification information.

Information received by the classification information receiving unit 110 is provided to the like or dislike information generation unit 120. In operation 903, the like or dislike information generation unit 120 generates like or dislike information based on the received information.

Like or dislike information is information generated by using information obtained when each first user, who subscribed for membership of the system in the present invention, classifies second users registered in an address book of each first user. Like or dislike information refers to information about how each user feels about other persons or information about how other persons feel about the user. As described above, like or dislike information may include integration of general classification information shown in FIG. 6, that is, information regarding a category into which another person classifies a user, information that shows a category into which a user classifies another person, shown in FIG. 7, information obtained by integrating momentary classification information that shows a feeling of another person about a user for a determined time period such as a day, as shown in FIG. 8, matching information that shows whether a certain person, who classifies a user into a same category into which the user classified the certain person, is present, and information that shows users who are classified into a certain category for a certain or higher rate by another person.

When like or dislike information is generated, the like or dislike information providing unit 130 transmits like or dislike information, generated by the like or dislike information generating unit 120, to the user's terminal in operation 904.

As described above, each user may set the user's classification information not to be provided, or not to be reflected in generation of matching information, and like or dislike information may not be provided to a user who set the user's classification information or matching information not to be provided to other users.

As described above, like or dislike information may be set not to be provided to users who have performed a classification operation on the users' address book at a predetermined or lower rate or for a predetermined number of times or less.

In operation 905, an application program installed in the user's terminal may receive such like or dislike information as shown in FIGS. 5 through 8 from the like or dislike information providing unit 130 and outputs the like or dislike information to the user's terminal.

As described above, according to the one or more of the above embodiments of the present invention, information regarding how another person feels about each user of terminals may be provided to each user of terminals, by using information that is obtained when each user of terminals classifies acquaintances in an address book.

Additionally, in the present invention, since a user may become aware of how the user is evaluated by another person, a positive effect may be obtained where the user may pay attention to the user's personal relationship, behavior, or so on.

In addition, other embodiments of the present invention can also be implemented through computer-readable code/instructions in/on a medium, e.g., a computer-readable recording medium, to control at least one processing element to implement any above-described embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments of the present invention. The media may also be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A like or dislike information providing system using an address book, the like or dislike information providing system comprising:
a classification information receiving unit for receiving classification information, which is obtained when a first user selects a second user who is registered in an address book of a terminal of the first user into one of predetermined categories, from the terminal of the first user;
a like or dislike information generating unit for generating like or dislike information that shows a like or a dislike which a third user, who selected the second user into one of the predetermined categories and who registered the second user in an address book of a terminal of the third user, has about the second user by using the classification information; and
a like or dislike information providing unit for providing the generated like or dislike information to the terminal of the second user.

2. The like or dislike information providing system of claim 1, wherein the classification information comprises momentary classification information that shows how the first user felt about the second user for a certain time period, and
the like or dislike information comprises information that is obtained by integrating the momentary classification information regarding the second user for the certain time period.

3. The like or dislike information providing system of claim 1, wherein the like or dislike information comprises information that shows, if the first user has classified the second users into a certain first category, whether a case when a person from among the second users who are classified into the first category classifies the first user into the first category is present.

4. The like or dislike information providing system of claim 1, wherein, with respect to a user who is classified into a certain second category from among the categories by other persons at a certain or higher rate, the like or dislike information providing unit generates information for outputting information, which shows the user is classified into the second category at the certain or higher rate, to an item that represents the user in the address book in which the user is registered.

5. A like or dislike information providing method using an address book, the like or dislike information providing method comprising:
receiving classification information, which is obtained when a first user selects a second user who is registered in an address book of a terminal of the first user into one of predetermined categories, from the terminal of the first user;
generating like or dislike information that shows a like or a dislike which a third user, who selected the second user into one of the predetermined categories and who registered the second user in an address book of a terminal of the third user, has about the second user by using the classification information; and
providing the generated like or dislike information to the terminal of the second user.

6. The like or dislike information providing method of claim 5, wherein the classification information comprises momentary classification information that shows how the first user felt about the second user for a certain time period, and
the like or dislike information comprises information that is obtained by integrating the momentary classification information regarding the second user for the certain time period.

7. The like or dislike information providing method of claim 5, wherein the like or dislike information comprises information that shows, if the first user has classified the second users into a certain first category, whether a case when a person from among the second users who are classified into the first category classifies the first user into the first category is present.

8. The like or dislike information providing method of claim 5, further comprising, with respect to a user who is classified into a certain second category from among the categories by other persons at a certain or higher rate, generating information for outputting information, which shows the user is classified into the second category at the certain or higher rate, to an item that represents the user in the address book in which the user is registered.

9. A non-transitory computer-readable recording storage medium having stored thereon a computer program, which when executed by a computer, for performing a like or dislike information providing method, the method comprising:
receiving classification information, which is obtained when a first user selects a second user who is registered in an address book of a terminal of the first user into one of predetermined categories, from the terminal of the first user;
generating like or dislike information that shows a like or a dislike which a third user, who selected the second user into one of the predetermined categories and who registered the second user in an address book of a terminal of the third user, has about the second user by using the classification information; and
providing the generated like or dislike information to the terminal of the second user.

10. The non-transitory computer-readable recording storage medium for performing the method of claim 9, wherein the classification information comprises momentary classification information that shows how the first user felt about the second user for a certain time period, and
the like or dislike information comprises information that is obtained by integrating the momentary classification information regarding the second user for the certain time period.

11. The non-transitory computer-readable recording storage medium for performing the method of claim 9, wherein the like or dislike information comprises information that shows, if the first user has classified the second users into a certain first category, whether a case when a person from among the second users who are classified into the first category classifies the first user into the first category is present.

12. The non-transitory computer-readable recording storage medium for performing the method of claim 9 further comprising, with respect to a user who is classified into a certain second category from among the categories by other persons at a certain or higher rate, generating information for outputting information, which shows the user is classified into the second category at the certain or higher rate, to an item that represents the user in the address book in which the user is registered.
